(19) United States
(12) Patent Application Publication
(10) Pub. No.: US 2013/0241222 A1
(43) Pub. Date: Sep. 19, 2013

(54) TAKE OUT JAWS WITH SEATED COMPONENTRY

(71) Applicants: Todd W. Bendure, Denton, TX (US); Nicu Lepadatu, Denton, TX (US); Shandon T. Fullingim, Decatur, TX (US)

(72) Inventors: Todd W. Bendure, Denton, TX (US); Nicu Lepadatu, Denton, TX (US); Shandon T. Fullingim, Decatur, TX (US)

(73) Assignee: POCO GRAPHITE, INC., Decatur, TX (US)

(21) Appl. No.: 13/824,909

(22) PCT Filed: Mar. 18, 2013
(86) PCT No.: PCT/US2011/052199

§ 371 Date: Jun. 4, 2013

Related U.S. Application Data
(60) Provisional application No. 61/384,099, filed on Sep. 17, 2010.
(60) Provisional application No. 61/384,125, filed on Sep. 17, 2010.

(51) Int. Cl. C03B 9/447

(52) U.S. Cl. CPC C03B 9/447
USPC 294/86.4; 29/402.08

(57) ABSTRACT

In an embodiment of the invention, a tong assembly for handling glass articles such as bottles, jars, and the like during the manufacture of same, utilizes replaceable matched pairs of components that vertically seat and are captured on features on the pair of tongs. The components may be in an interlocking, gravity restrained engagement and that may be replaced by lifting the components out of their interlocking engagement, removing them and replacing same by lowering the replacement components into the interlocking engagement whereby the replacement components are then captured and constrained by pairs of engagement surfaces. Lowering may be by lowering the entirety of the insert or lowering a portion such as the component is rotated into seating engagement. The components may be inserts held in place with the resiliency of spring clips that are themselves retained on the inserts also by the spring clips resiliency. Matched pairs of components are movable toward and away from one another as the tongs are closed and opened for grasping and releasing the upper portions of glass articles such as bottles and jars. The matched pair of components may be inserts for engaging the upper portion of the glass articles, the inserts captured within interlocking portions of takeout jaws. The matched pair of components may be protective covers.

### PRIORITY CLAIM

The present application is a National Phase entry of PCT Application No. PCT/US2011/052199, filed Sep. 19, 2011, which claims priority from U.S. Provisional Application No. 61/384,125, filed Sep. 17, 2010, and U.S. Provisional Application No. 61/384,099, filed Sep. 17, 2010, the disclosures of which are hereby incorporated by reference herein in their entirety.

### FIELD OF THE INVENTION

The present invention relates in general to glassmaking and, in particular, to an improved system, method, apparatus, and components relating to tong assemblies used in transferring hot glass bottles and like articles during the glass article manufacturing process. More particularly, the invention relates to tong assemblies with replaceable components such as inserts for grasping the glass articles.

### BACKGROUND OF THE INVENTION

Glass manufacturing has been around for centuries and has been and continues to be an important aspect of the world economy. In recent years, glass manufacturing has been overshadowed by the use plastics and other alternative materials in many product packaging and distribution markets. However, as concerns over the environment have increased, glass manufacturing has again been brought into the spotlight due to the recycling capacity of glass and the use of “natural” material. Glass requires a lower amount of embodied energy to produce, re-melts at a lower temperature and reduces landfill and water contamination when recycled properly. However, while glass may be more earth-friendly, the production of glass still suffers from production-line downtime and maintenance issues, sterility issues, and quality of glass, and strength of glass issues often due to the extreme age of the glass manufacturing equipment. Moreover, margins are very thin exacerbating issues associated with equipment down time and quality control.

Hot glass, especially when formed into various shapes in the manufacture of glass containers (e.g., bottles), is susceptible to being damaged by contact with glass processing equipment that is made of materials that have high conductivity properties such as metal. Metals engaged with near molten glass conduct heat away from the glass, causing uneven cooling, thus affecting the chemical bonds and resultant structure and strength of the glass formed in the molds. Thus, in various areas of the hot end processing of glass bottles, jars, and the like, it has been found desirable to utilize non-metallic materials such as graphite, asbestos, plastics or carbon fibers for engagement of just molded glass articles.

Conventionally, referring to FIGS. 28-31, tong assemblies 30 each with cooperating pairs of takeout jaw assemblies 32 are used to lift hot, newly formed bottles 34 or other articles from the mold in which they are formed and move them and release them on an air pad for cooling before being conveyed to an annealing furnace. Cooperating tongs 35 utilize non-metallic inserts 36 retained in takeout jaws 38. The non metallic inserts reduce the scratching or checking by contact with the hot formed bottles. While takeout jaws utilize graphite inserts to contact the bottles in many installations, the takeout jaw members may still break from the forces associated with the continual opening and closing of the takeout mechanism, the continual grasping of the glass articles and the conveyance of the glass articles. Conventional takeout jaws require frequent replacement of parts that become worn out due to this routine use in the glass article/bottle-forming process.

In conventional takeout jaws, the inserts are often received in receivers 38 on the takeout jaws that capture the top, bottom, lateral sides, and back side of the inserts, see FIGS. 20-23. The inserts are inserted into the receiving in a direction opposite to the grasping motion of the tongs, in the z direction as illustrated in FIG. 20. The inserts are inserted in a rearward horizontal direction and removed in a forward horizontal direction. The inserts are typically then held within the receivers by steel detent balls, or resistive curled springs 39 which are affixed to the takeout jaw via a screw 40. The receiver is configured as an arcuate channel with an upper wall 41, a lower wall 42, a back wall 44, and lateral walls 45, 46. The forces conveyed on the insert by the grasping, lifting, and conveyance of the glass articles are transferred to the takeout jaws and tongs by way of the engagement of the insert in the insert receiver and are transferred almost exclusively by surface to surface contact at the walls 41, 42, 44, 45, 46, specifically the horizontal surfaces and vertical surfaces. Notably the insert is constrained upwardly by upper wall 41.

The detent balls may fail due to wear and fouling caused by the accumulation of grease, oil, and other foreign matter. Failure may occurs when the detent balls fail to descend into the takeout jaw aperture thereby permitting the insert to fall out, causing loss of the insert and potential damage to the newly formed glass bottles. In addition, the resistive springs often times lose their effectiveness over time, due to the grease, oil and foreign matter, as well as to the loss of retaining capacity due to the extreme temperature differential and the repeated bending of the resistive spring member. Thus, as the take out jaw is used in the manufacturing process, where the resistive spring is unable to retain the insert in the takeout jaw aperture, failure of the tong-insert engagement occurs and production is interrupted. A further issue is the loss of the retaining screw that retains the resistive spring member in operational contact with the takeout jaw and insert by the screw coming loose or if the screw otherwise fails or breaks. Such failure can result in the screw or parts getting into the glass assembly line machinery requiring stoppage and/or causing damage. In addition, where the screw fails, the threaded portion of the screw may be retained in the takeout jaw thus requiring the takeout jaw itself to be replaced which can be costly and time consuming. Moreover, any failed components have the possibility of ending up in the bottles or glass articles being manufactured.

Further, while prior designs of takeout jaws attempted to provide a single design that could handle both “floating” (some movement in the insert allowed) and “fixed” (no movement in insert allowed) the designs still result in significant downtime due to their complexity and the number of parts, which may include the detent balls, resistive spring with screw or a combination of both. Thus, while prior designs may allow use of a single takeout jaw design with variable insert widths in situations where a fixed or floating takeout jaw is required, current designs are insufficient in providing enough manufacturing “uptime” and takeout jaw reliability. Over time the inserts in current takeout jaw may still produce wear on the detent balls and retaining springs thus allowing inserts to disengage during glass article manufacturing and be lost.

Takeout jaws typically require custom machining due to their relatively low volume of production, special materials, and specific application. Thus, the reliability of the takeout jaw is of the utmost importance. The longer the wear on the takeout jaw assembly, the better, as custom machined takeout jaws can be expensive and may further increase downtime if the wear is not anticipated.

If a takeout jaw tong assembly loses function, the glass assembly line has to be shut down, deeply cutting into the line's production, thus affecting margins. Any means for expediting replacement of worn or damaged components can minimize the down time.

Due to at least the issues presented above, a need exists for a takeout jaw that is reliable, light weight, able to be utilized in both fixed and float assembly lines, low-cost, easily machined, easily serviceable and simple to maintain.

### SUMMARY OF THE INVENTION

In an embodiment of the invention, a tong assembly for handling glass articles such as bottles, jars, and the like during the manufacture of same, has a pair of jaws that utilizes replaceable matched pairs of components that vertically seat and are captured on features on the pair of tongs in an interlocking, gravity seated engagement and that may be replaced by lifting the components vertically out of their interlocking engagement, horizontally unengaging the components, then removing them and replacing same by lowering the replacement components into the interlocking engagement whereby the replacement components are then captured. The matched pair of components are movable toward and away from one another as the tongs are closed and opened for grasping and releasing the upper portions of glass articles such as bottles and jars.

In an embodiment of the invention, utilizing the x-y-z coordinate axis, a pair of tongs are suspended downwardly, in the y direction, and close and open in the z direction. Each of the takeout jaws, also known as an insert holder, has a base for receiving inserts and tong attachment portions extending upwardly in the y direction. Matching pairs of components may be attached to the insert holders by vertically lowering them into position and providing component to insert holder constraint to fix the location in the x-z plane, to provide an upwardly facing constraint (which precludes downward motion by the component) in they direction by gravitational seating by the component on and in the insert holder. The constraints that fix the location in the x-z plane provide vertical or upright face to face engagement in at least two upright and transverse planes which limits any rotation about a horizontal axis. Such vertical face to face engagement may be provided in the x-y plane restricting movement of the component in the z direction and in the y-z plane limiting movement in the x direction. A range of rotational movement about an axis extending in the z direction may be permitted in certain embodiments, for example, less than 2 degrees, or less than 4 degrees, or less than 6 degrees, or less than 10 degrees. Such may be provided by one or a pair of curved upward constraints with each curvature extending about an axis in the z direction.

In an embodiment of the invention, a pair of face to face engagements between the component to be seated and the insert holder are present in the x-y plane, another pair of face to face engagements are present in the z-x plane and another pair of face to face engagements in the y-z plane. Each pair of engagements has the component engaging face and the insert component face oriented in opposite directions thereby providing precluding any relative motion between the component and insert holder in a direction transverse to the plane. The face to face engagement between the component and insert holder with the insert holder engagement face oriented upwardly provides a seating surface for the component.

In an embodiment of the invention, a tong assembly for handling glass articles such as bottles, jars, and the like during the manufacture of same, utilizes replaceable glass engaging components passively interlocked in place on a pair of takeout jaws by cooperating constraining and constrained surfaces, the glass engaging components being removable and replaceable by vertically raising the components to unseat same and lowering new components into engagement with the takeout jaws. The tong assembly may comprise a pair of cooperating jaws, each jaw comprised of a tong bracket, a takeout jaw attached to the bracket, and a removable and replaceable insert for engagement with the glass article. Said insert being one of a pair with a cooperating insert on the cooperating takeout jaw whereby the two cooperating inserts grasp an upper outer circumferential surface of the glass article, such as a bottle. Each of the inserts having an inner or front portion configured as a article interface-grasping portion and a rear interlocking portion configured for interfacing and interlocking with the takeout jaw at an interface portion of the takeout jaw. The insert at said interlocking portion seatable vertically with the insert interface portion of the takeout jaw by lowering the insert into an interlocking engagement. Said interlocking engagement providing bottom, lateral, forward, backward, and rotational constraints. The insert may be secured in place solely by gravity and substantially constrained against any movement with respect to the takeout jaw except a vertical takeout movement and then a horizontal movement to release the insert from the interlocking engagement.

In particular embodiments, the face to face engagements may be formed with curved faces rather than planar faces. Such cooperating curved surfaces then can avoid cooperating pairs of planar faces to provide appropriate constraints to allow the insert to be removable upwardly but otherwise secured in position.

In an embodiment, the interlocking portion comprises forwardly, inwardly and rearwardly outwardly facing vertical planar surfaces, as well as lateral vertical planar surfaces, all of which confront cooperating planar surfaces on the takeout jaw. Said planar surfaces extending the vertical thickness or substantially the vertical thickness of the insert. The insert is secured within or about the takeout jaw by said confronting surfaces. Said confronting surfaces providing a fixed seating of the insert with respect to the takeout jaw. Unseating accomplished by a straight upward motion, without rotational components and a further horizontal motion may then completely remove the insert from the takeout jaw. In certain embodiments of the invention, there are no detents, mechanical attachments brackets or physical barriers to removal of the insert, that is, the unseating of the insert, other than overcoming the minor gravitational pull effecting the seating and providing a force and motion in the proper direction for unseating and another force and motion in a second direction for removing the insert.

A feature and advantage of the invention is that the applicants have recognized that the normal forces associated with grasping, lifting, conveying, and releasing glass articles, such as bottles and jars, do not impart a distinct vertical force to the insert and therefore a downward constraint on the insert with respect to its engagement with the takeout jaw is not needed and in fact the lack of such constraint is utilized for unseating, removing, and replacing inserts in the takeout jaws.

A feature and advantage of embodiments of the invention is that worn or damaged inserts may be removed by lifting the insert up vertically to unseat the insert, without a rotational component, and said insert may be replaced by positioning the new insert over the takeout jaw insert seat and then by the new lowering vertically the replacement insert, again, with no rotation component.

A feature and advantage of embodiments of the invention is that no fasteners or brackets or other parts are utilized in retaining the inserts within the takeout jaw and all features that provide the interlocking and retention are part of the insert and the takeout jaw.

A feature and advantage of embodiments of the invention is that a quick and simple replacement of inserts may be accomplished required fewer steps and/or effort than known replacement methods.

A feature and advantage of embodiments of the invention is that there is no or minimal risk of components, screws, or brackets being dropped or falling into the equipment or glass articles as compared to the prior art.

In an embodiment of the invention, the confronting constraining and constrained surfaces may have curvature. Said curvature may be complex and may be on vertical surfaces, surfaces angled from vertical, horizontal surfaces, on horizontal surfaces. Such curvatures may be partial frusto-conical, partial frusto-spherical, partial frusto-bowl shaped, or combinations of these. The takeout jaw will have surfaces that confront these shapes and will, in embodiments, such surfaces of the insert may be concave and the corresponding cooperating and confronting surfaces of the takeout jaw will be convex.

A feature and embodiment of the invention is that multiple cooperating coextensive engagement surfaces minimize stresses on the components minimizing breakage and failures.

In an embodiment of the invention, the insert of the takeout jaw assembly has an I-shaped portion with the middle portion of the “I” resting on a bottom seating surface of the takeout jaw with the upper legs and lower legs of the “I” restricting any movement between the insert and takeout jaw other than a vertical removal motion.

In an embodiment of the invention, the insert of the takeout jaw assembly has a pair of C-shaped cutouts on the lateral sides of each insert, the surfaces that define the C-shaped cutout confronting vertical cooperating portions of the takeout jaw. The C-shaped cutout portions positioned at or adjacent to an outer portion of the insert that is opposite the inner portion having the grasping, in proximity to the side. The C-shaped cutout portions can face inwardly or outwardly. When facing outwardly the insert may seat within an aperture of the takeout jaw. When the C-shaped cutout portions are facing inwardly, they may wrap around the body of the takeout jaw.

In an embodiment of the invention the insert has a T-shaped portion extending and at the side opposite the article grasping side, the T-shaped portion insertable into an aperture in the takeout jaw, said aperture configured to receive the lower leg of the T with the upper two legs positioned on one side of the takeout jaw and the article grasping portion on the opposite side.

In an embodiment of the invention the insert is engaged with the takeout jaw such that it cantilevers out from the takeout jaw towards the cooperating insert on the cooperating takeout jaw.

In an embodiment of the invention, respective interlocking portions of the takeout jaws and inserts may be utilized for removable attaching protective covers. In that the covers do not engage the hot glass, they may be of metal. The cover may have a takeout jaw interface portion with a substantially rectangular aperture for placement over the takeout jaw bracket attachment portion to rest on shoulders configured in the body portion of the takeout jaw.

In an embodiment of the invention, the interlocking engagement between the takeout jaw and inert can be configured to provide a certain amount of float as desired. The float can be in the form of a partial capability of the insert to partially rotate about one or more axis, or the float can be a capability of the inert to move in an upward direction.

A feature and advantage of the invention is that the applicants have recognized that the normal forces associated with grasping, lifting, conveying, and releasing glass articles, such as bottles and jars, do not impart a distinct vertical force to the insert and therefore a downward constraint on the insert with respect to its engagement with the takeout jaw is not needed and in fact the lack of such constraint is utilized for unseating, removing, and replacing inserts in the takeout jaws as well as adding considerable simplicity to the attachment and retention features associated with inert holders and inserts.

In an embodiment, an insert is retained in a takeout jaw by utilizing a novel tooth and notch system. This system functions similarly to previous embodiments; however, the insert must be rotated prior being inserted into a slot in the takeout jaw. Once inserted, the insert is rotated back to a substantially horizontal position, and a tooth towards the outside of the insert engages a notch towards the outside of the slot in the takeout jaw. Notably, the insert is effectively cantilevered from the takeout jaw, so that the weight of the insert and the weight of a glass object held by the insert, if present, applies a moment on the insert, thereby pressing the insert tooth portion into the notch, securing the insert to the takeout jaw. Z-direction movement is also constrained; a vertical notch member abuts insert hook portion which prevents inward z-direction movement, and the insert shoulder abuts takeout jaw inner surface which prevents outward z-direction movement.

In an embodiment of the invention an insert holder assembly for a pair of tongs utilizes one or more arcuate spring clips with attachment tabs. The spring clips removably secure inserts in an insert receiving slot of an insert holder. The arcuate spring clips utilize a spring clip interface portion such as pairs of holes on each side of the insert holders. The holes are suitably spaced and the spring configured to require the respective spring to be flexed, such as compressed inwardly to allow the tabs to be inserted in the holes. The tension in the respective spring is released after the tabs are extending through the holes, thereby capturing the spring securing the spring in place. The arcuate shape of the spring at the midportion of the spring extends into the insert slot providing an interference with inserts that are received by the slot. A cutaway or arcuate recess positioned on the side of the inserts cooperates with the arcuate spring when the insert is fully received in the insert holder such that the insert is secured in place. Opposing spring clips on opposite sides of the insert holder slot may cooperate to further enhance the retention of the insert within the slot.

A feature and advantage of embodiments of the invention are the very limited number of parts that comprise the takeout jaw assembly, no supplemental fasteners are utilized for the insert retention mechanism.

A feature and advantage of embodiments of the invention is that the spring resiliency of the spring clips provides for the entrapment of the spring clip to the insert holder, that is the retention of the spring clip in the insert holder without an insert therein, as well as providing resiliency for retention of the inserts when installed in the insert holder.

A feature and advantage of certain embodiments of the invention in which the arcuate spring clips have tabs arranged to extend outwardly, when said spring clips are seated in the insert holder, and when an insert is being inserted therein, the arcuate spring extends, that is, the arcuate shape flattens, whereby the tabs are urged outwardly, in the direction opposite to the direction needed to release the spring from the insert holder. This effectively locks the spring clips in place when they are being utilized for retention of the inserts. That is, the flexing of the spring clips upon installation of an insert extends the spring clip lengthwise which is opposite to the compression needed to remove the spring clips from the retention holes in the insert holder.

A feature and advantage of the invention is that the strength of the retention of the insert within the insert holder, as well as the rigidity of the insert with respect to the insert holder can be adjusted by utilizing different spring clips with slightly different dimensions and characteristics, specifically spring force.

The takeout jaw assemblies address issues presented by current and prior art takeout jaws discussed in the BACKGROUND. The interior spring takeout holder takeout jaw assembly may be lighter than conventional takeout jaws, is able to be utilized in nearly any assembly line, is easily machined and producible in small quantities, is easily serviceable, is of relatively low cost, is a simple form, and requires no external fasteners, or retaining balls.

### BRIEF DESCRIPTION OF THE DRAWINGS

FIG. 1 is a perspective view of a tong assembly according to an embodiment of the invention;

FIG. 2 is a perspective view of a takeout jaw assembly according to one embodiment;

FIG. 3 is an exploded perspective view of the takeout jaw assembly of FIG. 2;

FIG. 4a is a perspective view of an insert form before halving, according to one embodiment;

FIG. 4b is a perspective view of the opposite side of the insert form of FIG. 4a;

FIG. 5 is a plan view of cooperating inserts in association with their respective takeout jaws in partial section;

FIG. 6 is a plan view of cooperating takeout jaw assemblies including inserts and protective covers;

FIG. 7a is a side elevational view and partial sectional view (taken at line 7-7 of FIG. 5) of cooperating takeout jaw assemblies of FIG. 6;

FIG. 7b is a side elevational view and partial sectional view (taken at line 7-7 of FIG. 5) of cooperating takeout jaw assemblies utilizing the dual thickness inserts as illustrate in the forms of FIGS. 4a and 4b;

FIG. 8a is a perspective view of a takeout jaw in which the insert may be attached externally according to an embodiment of the invention;

FIG. 8b is a front elevational view of the takeout jaw of FIG. 8a;

FIG. 9 is a top plan view of the takeout jaw of FIGS. 7 and 8;

FIG. 10 is a perspective side view of cooperating inserts suitable for the takeout jaw of FIGS. 7, 8, and 9;

FIG. 11 is a cross sectional view taken at the line 11-11 of FIG. 10;

FIG. 12 is a perspective view of a pair of cooperating takeout jaws with an externally attached insert and protective cover attached to one jaw and the insert and protective cover shown in an exploded view with respect to the other jaw;

FIG. 13 is a perspective view of cooperating takeout jaw assemblies;

FIG. 14 is a side elevational view of the takeout jaw assemblies of FIG. 13;

FIG. 15a is an exploded perspective view of protective covers and takeout jaws;

FIG. 15b is a perspective view of the protective covers and takeout jaws of FIG. 15a in engagement;

FIG. 16a is a perspective view of a protective cover and takeout jaw according to an embodiment of the invention;

FIG. 16b is a perspective view of the protective cover and takeout jaw of FIG. 16a assembled;

FIG. 17 is a side view of a the takeout jaw assemblies of FIG. 16;

FIG. 18 is a top plan view of the takeout jaw assemblies of FIG. 16;

FIG. 19 is a perspective view of an insert in accord with an embodiment of the invention;

FIG. 20 is a perspective view of a takeout jaw with the insert of FIG. 19 seated on and attached thereto by an interlocking arrangement;

FIG. 21 is a rear perspective view of the assembly of FIG. 20;

FIG. 22 is a plan view of assembly of FIGS. 20 and 21;

FIG. 23 is an exploded perspective view of an insert holder and insert in accord with embodiments of the invention;

FIG. 24 is the insert and takeout jaw of FIG. 23 assembled with the insert seated and interlocked with the insert holder;

FIG. 25 is a front elevational view of the takeout jaw assembly of FIG. 24;

FIG. 26 is the front elevational view as in FIG. 25 but with the insert showing partial rotation about a horizontal axis;

FIG. 27 is a plan view of the assembly of FIG. 24;

FIG. 28 is a PRIOR ART pictorial view of the takeout area of a bottle-making machine showing takeout jaws in position over recently molded glass bottles;

FIG. 29 is a perspective view of a PRIOR ART takeout jaw and insert;

FIG. 30 is a cross-sectional view of the PRIOR ART insert of FIG. 29 being inserted into the receiver of the takeout jaw;

FIG. 31 is a cross-sectional view of the PRIOR ART insert of FIG. 29 fully inserted and retained by a spring clip;

FIG. 32 is perspective view of a takeout jaw and insert assembly in accord with an embodiment of the invention;

FIG. 33 is an exploded view of the assembly of FIG. 32;

FIG. 34 is a cross-sectional view of the assembly of FIG. 32, taken along plane 34 as shown in FIG. 32;

FIG. 35a is a detail view of the cross-sectional view of FIG. 34, illustrating an insert partially installed into a takeout jaw, in accord with an embodiment of the invention; and

FIG. 35b is a detail view of the cross-sectional view of FIG. 35, illustrating an insert fully installed into a takeout jaw, in accord with an embodiment of the invention.

FIG. 36 is a perspective view of the takeout area of a bottle-making machine showing takeout jaws in position over recently formed glass bottles according to an embodiment of the invention;

FIG. 37 is a perspective side view of a tong set with interior spring takeout holder assemblies according to an embodiment of the invention;

FIG. 38 is a perspective side view of an insert holder with an insert in place according to an embodiment of the invention, the view from the opposite side being a mirror image thereto;

FIG. 39 is a front elevational view of an insert holder according to an embodiment of the invention;

FIG. 40 is an exploded perspective view showing an insert holder and pair of arcuate spring clips with engagement tabs according to an embodiment of the invention, the view from the opposite side being a mirror image thereto;

FIG. 41 is an exploded perspective view showing an insert holder and insert according to an embodiment of the invention, the view from the adjacent front corner being a mirror image thereto; the view from the bottom side of the insert being identical to the view from the top side;

FIG. 42 is an elevational view of the back of the insert holder of FIGS. 5, 6, and 7;

FIG. 43 is a cross sectional view of the insert holder of FIG. 4 taken at line 8-8 with a single spring in place;

FIG. 44 is the cross sectional view of FIG. 8 with two spring clips and an insert in place;

FIG. 45 is a perspective view of an arcuate spring with engagement tabs according to an embodiment of the invention;

FIG. 46 is a front elevational view of an insert in accord with the invention herein;

FIG. 47 is a perspective view of an insert holder in accord with the invention herein; and

FIG. 48 is a perspective view of a further embodiment of an insert holder in accord with the invention herein.

FIG. 49 is a perspective view of a further embodiment of an insert holder and insert in accord with the invention herein.

### DETAILED DESCRIPTION OF EMBODIMENTS

Embodiments of the tongs and takeout jaw assemblies of the present invention address the issues presented by prior art takeout jaws presented above. The takeout jaw assemblies of the inventions herein are light weight, are readily utilized in most exiting bottle production lines, are readily machined, are easily producible in small quantities, provide easily serviceability, are relatively low cost and are of a simple form.

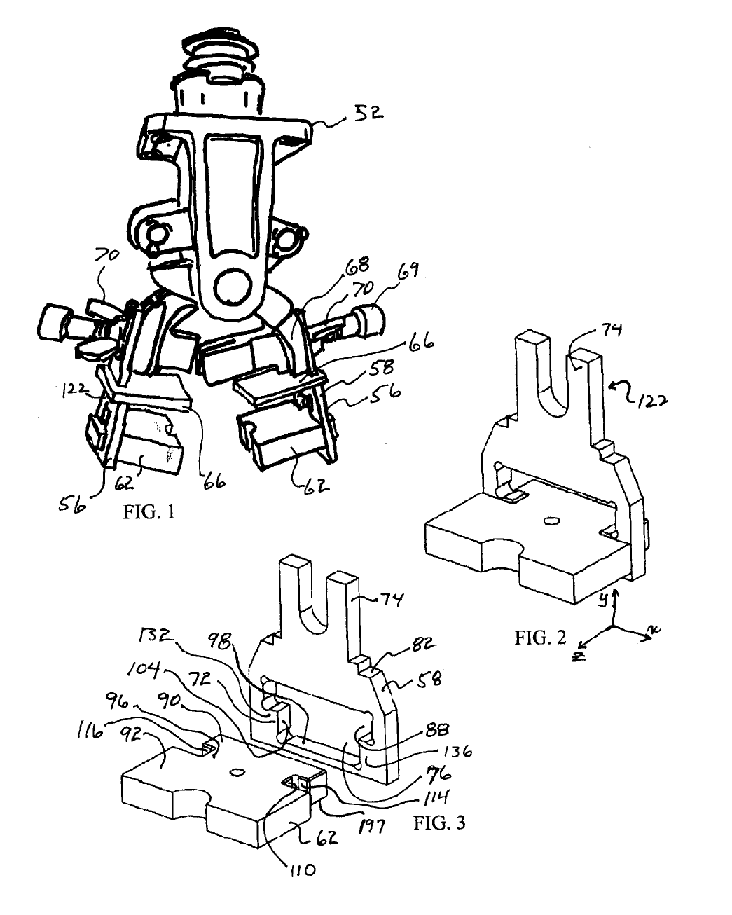

FIG. 1 illustrates a tong assembly 52 with takeout jaw assemblies 56 in accord with embodiments of the invention suitable for use in bottling apparatuses such as that shown in FIG. 28. The takeout jaw assemblies 56 each include a takeout jaw 58, an insert 62, and a protective cover 66. The takeout jaws 58 attach to brackets 68 and may interface with hot glass bottles 34 or other glass articles which have been removed by tong assembly 52 from a hot glass mold. The tong assembly 52 conveys the hot glass bottles 34 or articles to cooling regions and/or a conveyor for transfer to an annealing furnace or other process used to further refine the cooled glass bottles 34 or articles.

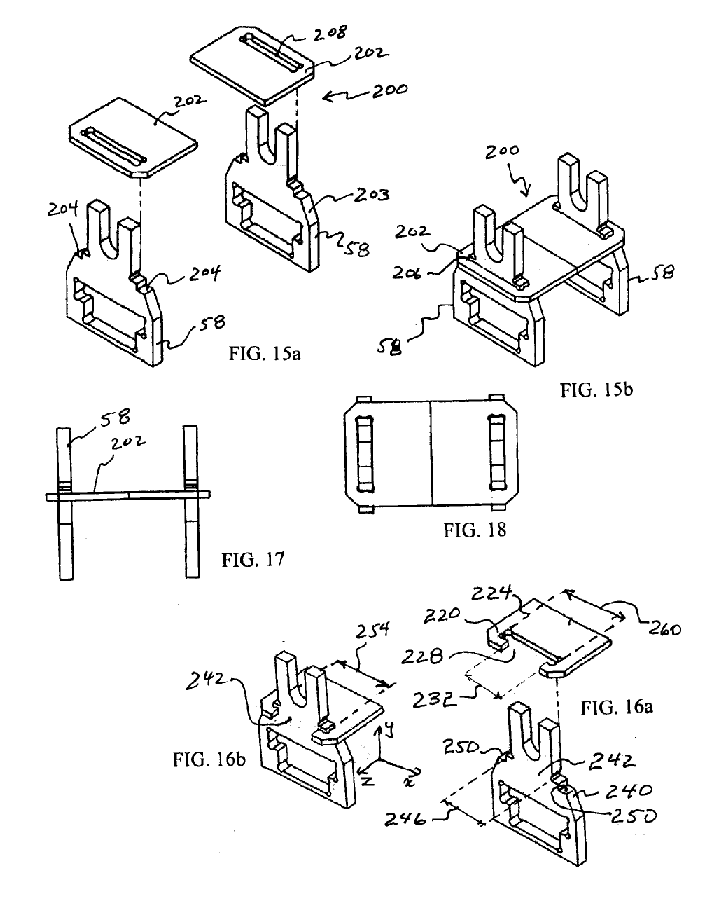

In FIGS. 2 and 3, a single takeout jaw 58 and cooperating insert 62 is illustrated. Takeout jaw 58 may be milled, forged or stamped of metals such as steel, iron, aluminum, bronze and alloys of same. Takeout jaw 58 has a takeout jaw insert interlock or interface portion 72 and a tong assembly interface portion 74 for attachment to the tong bracket 68. The takeout jaw insert interface portion 72 has an opening 76 in its center, which may be “T” shaped, and may include upper receiving slot 88 and lower seating slot 94. The opening 76 may further include a plurality of substantially circular corner openings 78 to minimize manufacturing tolerance issues and aid in easy assembly of the components. In addition, the opening 76 may allow for a maintenance worker to quickly change inserts, due to the absence of any detents, clips or other modes of maintaining a configuration. In many embodiments, interface portion 72 is configured to utilize only gravity to maintain engagement between the takeout jaw insert 62 and the takeout jaw 58. Takeout jaw 58 may further include a shoulder 82 for retaining a protective cover; see discussion relating to FIGS. 15-18, below.

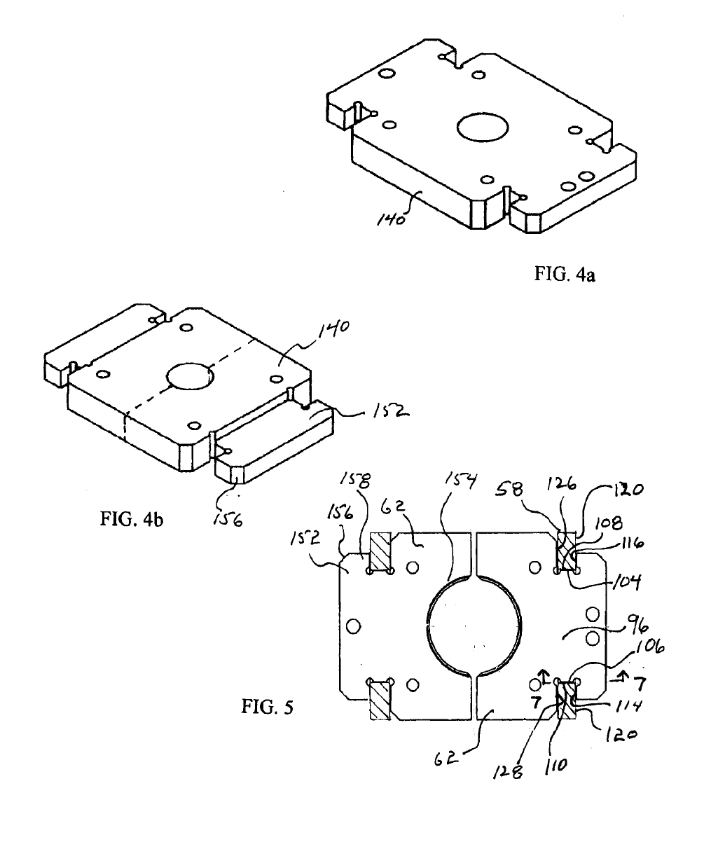

In FIGS. 2-5, key features of insert 62 are illustrated. A form 140 with two thicknesses 142, 144, is cut along center line 141 to form corresponding inserts 62a and 62b. Inserts 62a and 62b, respectively, comprise body portion 92 of thickness 142, and interface portion 90 of thickness 144. Because the moment exerted on takeout jaw 58 by the weight of the bottle 34 that is grasped by insert 62 is supported by both the back face 122 and by the front interface portion 72 of takeout jaw 58, thickness 144 of insert interface portion 90 can be less thick than thickness 142 of insert body portion 92.

Referring to FIGS. 2, 3, 5, and 7a, the details of the interlocking relationships between takeout jaws 58 and inserts 62 are illustrated. Interlocking portion 72 of takeout jaw 58 has an insert receiving slot 88 into which the interlocking portion 90 of insert 62 may be horizontally inserted. The interlocking portion 90 may appropriately be T-shaped and projecting from the body portion 92 of the insert 62. The receiving slot 88 of the takeout jaw 58 is sized to allow the insert interlocking portion 90 to pass therethrough. The receiving slot 88 may also have a seating slot 94 that is sized to cooperate with the lower leg of the T, that is, the neck portion 96 of the insert. The seating slot 94 is defined by a horizontal seating surface 98 that confronts the lower surface 97 of the insert and by vertical surfaces 104, 106. The vertical surfaces 104, 106 may be planar and confront the vertical surfaces 108, 110 of the insert neck portion 96. The forward facing vertical surfaces 114, 116 of the arms of the “T” of insert 62 confront the rearwardly or outwardly facing surface 120 of the back side 122 of the takeout jaw. Similarly, the rearwardly or outwardly facing vertical surfaces 126, 128 of the T of insert 62 confront and engage the vertical surfaces 132, 136 of the takeout jaw body adjacent the opening 76 of takeout jaw interface portion 72. Along with the seating of the neck 96 on the horizontal seating surface 98, the forward-backward confrontation and engagement of the vertical surfaces is the primary structural support providing resistance to the force provided by the weight of the bottles 34 when grasped by the inserts 62. The grasping and support of the bottles 34 provides both a compression and a moment at the engagements between the inserts 62 and takeout jaws 58. Notably these forces are lateral, downward, or in the form of a moment and the interlocking engagement and seating engagement effectively resist these forces. The forces do not normally impart a pure upward force that would unseat the insert 62 from the takeout jaws 58.

In maintenance, an operator may insert a takeout jaw insert 62 by simply directing the takeout jaw interface portion 90 into the upper insert receiving portion 88 of the takeout jaw opening 76 and then dropping the takeout jaw insert 62 into the lower interlocking portion 90 of the takeout jaw opening 76. Thus, the operator need not utilize a significant amount of force in inserting takeout jaw inserts 62. Similarly, in removing the takeout jaw insert 62, an operator need only lift the takeout jaw insert 62 from the lower interlocking portion 90 of the takeout jaw opening 76 to the upper receiving portion 88 of the opening 76 and slide the takeout jaw insert 62 clear. As such, the takeout jaw insert 62 requires minimal effort in insert and removal while utilizing force such as gravity and friction to retain the takeout jaw insert 62 in tight configuration with the takeout jaw 58.

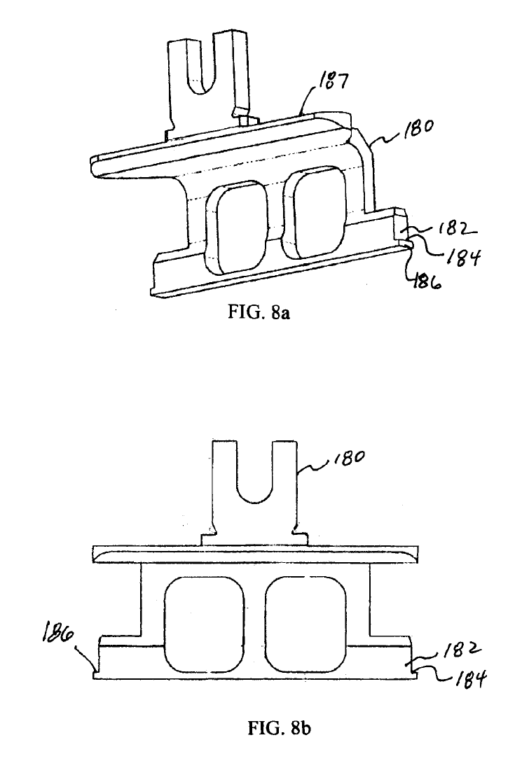

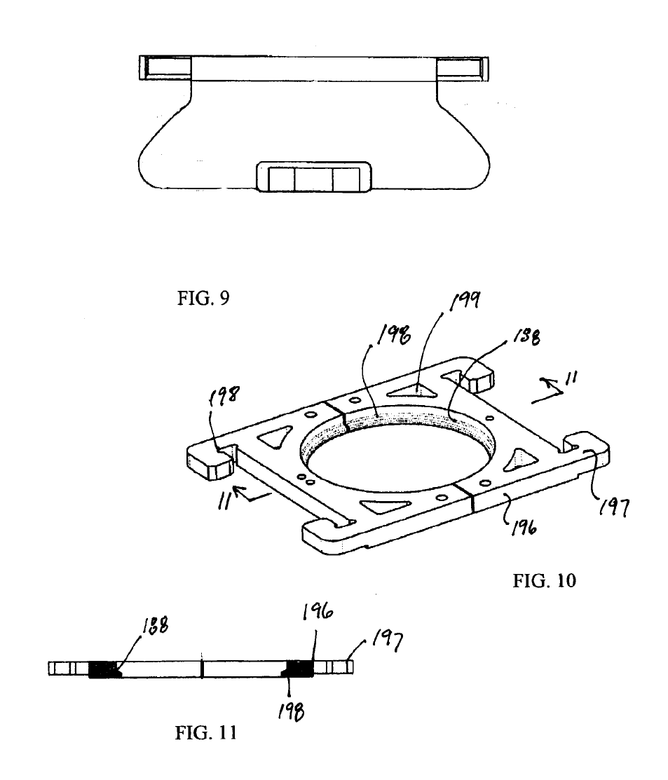

Now referring to FIGS. 8a-14, an alternate embodiment of the cooperating takeout jaw assemblies 175 are depicted. In this embodiment, each takeout jaw 180 has a takeout jaw insert interface portion 182 that is offset rearwardly in an outward direction by a horizontally extending midportion 187, thereby increasing clearance between opposing interface portions of a set of jaws 180 as part of a tong assembly 175. This allows for takeout jaws 180 to accommodate jars, or glass articles with large openings. The takeout jaw 180 may still be milled from a metal or metal alloy such as steel, iron, aluminum, bronze or the like. The takeout jaw insert interfaces 182 may include a slight bevel 184 and may have a plurality of insert seats 186. The beveled edges 184 and seats 186 act to allow for more efficient insert installation and maintenance.

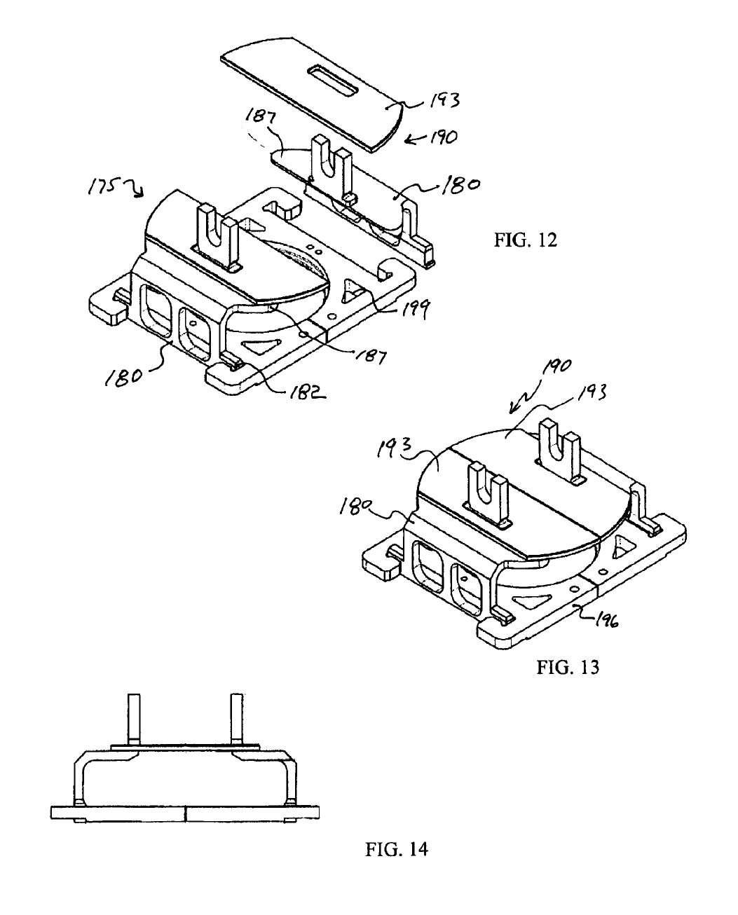

FIGS. 12-14 depict a cover system 190 for takeout jaws 180 according to another embodiment. In this embodiment, the cover system 190 interfaces with the horizontally extended portion 187 of the takeout jaw 190 and comprises a cover 193. The takeout jaw cover system 190 may utilize forces such as gravity, friction, and constraining surfaces to secure itself to the takeout jaw 180. The cover system 190 of this embodiment provides protection from grease, oil, and other foreign matter as well as acting as a tong assembly stop if needed. In various embodiments the cover system 190 is not permanently affixed to the takeout jaw 180, which allows the covers 193 to be removed or replaced. In this way, the cover system 190 may protect the molded glass from debris and can be readily replaced in a situation where cover 193 is damaged.

FIGS. 10 and 11 depict an alternate embodiment of a takeout jaw insert 196 suitable for the takeout jaw 180 of FIGS. 8a and 8b. As mentioned above, the takeout jaw insert 196 may be formed of a non-conductive, yet strong, insulating material such as graphite. The takeout jaw insert 196 may have a takeout jaw interface portion 197 and a molded glass interface portion 188. The takeout jaw interface portion 197 may be substantially rectangular or may be substantially “C” shaped. The takeout jaw interface portion 197 may have opened corners 198 on the interior corners of the “C” so as to allow increased tolerance in maneuvering and aligning the takeout jaw insert 196 for interface with the takeout jaw 180. Further the takeout jaw interface portion 197 may have a plurality of takeout jaw retaining portions 195 that interface with the takeout jaw 180 and secure the takeout jaw insert 196 utilizing force such as friction and/or gravity. The takeout jaw insert 196 may have a plurality of takeout openings 199. These openings 199 may reduce the weight of the takeout jaw insert 196.

In maintenance, an operator may insert a takeout jaw insert 196 by simply directing the takeout jaw interface portion 197 over the takeout jaw insert interface portion 182 and then dropping the takeout jaw insert 196 into the lower portion of the takeout jaw insert interface portion 182 to the takeout jaw insert interface seat 186. Thus, the operator need not utilize a significant amount of force in inserting takeout jaw inserts 196. Similarly, in removing the takeout jaw inserts 196, an operator need only lift the takeout jaw insert 196 from the takeout jaw interface seat 186 above the takeout jaw insert interface portion 182 and slide the takeout jaw insert 196 clear. As such, the takeout jaw insert 196 requires minimal effort in insert and removal while utilizing force such as gravity and friction to retain the takeout jaw insert 196 in tight configuration with the takeout jaw 180.

Further, the takeout jaw insert 196 as illustrated has substantially semi-circular molded glass contact edges 188. The molded glass contact edges 188 may have threaded contact edges, or may be ridged contact edges as depicted in FIG. 10. In various embodiments the molded glass contact edge 188 profile design may be altered in order to accommodate various different molded glass designs. In this way, the takeout jaw 180 may be utilized in a variety of assembly lines that form a variety of glass types. Further, variations in the glass contact edges 188 allow for varying amounts of play and float that are required on various production lines.

FIGS. 15-18 illustrate a takeout jaw cover system 200 with protective covers 202 that may be formed of a metallic material or metal alloy such as steel, iron, aluminum or bronze, or of any suitable polymer-based material. The cover system 200 may act to prevent grease, oil and other debris from contacting the takeout jaw 58 or molded bottles 34. As mentioned above, the prevalence of the grease, oil and other debris is a significant issue in glass assembly lines as it may cause the assembly line machinery to wear quickly and more importantly, the foreign material may affect the molded glass sterility and strength. As such, the cover system 200 may act to increase the longevity of the takeout jaw 58 while at the same time increasing the quality of the molded glass produced on the assembly line. In various embodiments the cover system 200 will seat on the takeout jaw shoulder 204. The cover system 200 may be formed in such a manner that it will utilize forces such as gravity and friction to secure itself to the takeout jaw 58. For example the vertical surfaces of the cover 202 and the takeout jaw 58 engage on one another in close tolerances. The covers 202 have a takeout jaw engagement portion 206 that includes an aperture 208 that fits over the tong assembly interface portion 74 to seat on the shoulders 204. Thus, in various embodiments the cover system 200 is not permanently affixed to the takeout jaw 58, which allows the cover system 200 to be removed or replaced. In this way, the cover system 200 may protect the molded glass from debris and can be readily replaced in a situation where the cover 202 is damaged. Utilizing the cover system 200 may help increase the wear life of the takeout jaws 58 and takeout jaw inserts 62.

FIGS. 16a and 16b illustrate an embodiment of the covers 224 that attach to takeout jaws 240 in the manner as described in the text associated with FIGS. 2-5. The interface portion 220 of the cover 224 has C-shaped cutout 228. The cutout 228 has an opening width 232. The takeout jaw 240 has a neck portion 242 with a width 246, which is smaller than the width 232 of the opening 228 of the cover. The cover 224 may seat on shoulders 250 at which level the width 254 of the neck portion 242 is within close tolerance to, but slightly smaller than the width 260 of the inside of the C-shaped cutout 228. The cover 224 and takeout jaw 240 may have vertical surface-to-surface engagements in the x-y plane on opposing sides of the takeout jaw 240 to secure the cover 224 at an appropriate angle to the takeout jaw 240—typically a right angle. In certain embodiments, the vertical surface-to-surface engagements may have a slight inward orientation that is tilted at the upward surfaces to provide a progressively tight fit as the cover 224 is lowered onto the seating position. Notably, gravity as well as friction between the pieces can maintain the engagement between the cover 224 and takeout jaw 240. The embodiment of FIGS. 16a and 16b allows the cover 224 to be removed without removal of the takeout jaw 240 from the tong brackets 68. Similarly, the takeout jaw 240 and insert 62 can have tapered or tilted vertical or near vertical surfaces to promote a locking arrangement.

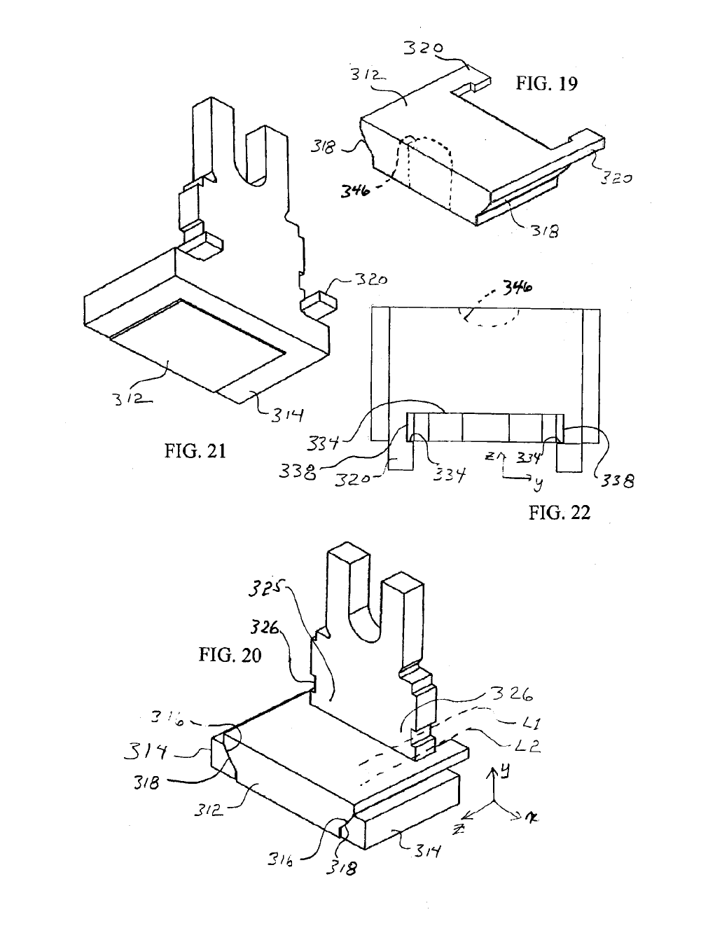

Referring to FIGS. 19-26, further embodiments are illustrated in which the insert holder 310 has additional engagement features as compared to the various takeout jaws described above. FIGS. 19-21 illustrate an insert holder 310 with forwardly extending arms 314 that provide underneath support for insert 312, but provide no support in the z direction. The underneath support provided by arms 314 comprises a pair of curved surfaces 316 that engage cooperating curved surfaces 318 of the insert 312. The insert 312 has rearwardly extending arms 320 that together provide an insert attachment structure with a “C” shape or individually an “L” shape, both extending in a horizontal plane. The insert holder 310 has a narrowed portion 326 which allows horizontal insertion of the insert 312 into a surrounding relationship with the insert holder 310 at a level L1 and then lowered to a seating level L2 where three pairs of engagement faces 334 in the x-y plane are provided, as well as a pair of engagement faces 338 in the x-z plane, best illustrated in FIG. 22. The insert 310 will have a suitable cutout 346 for grasping a glass article as illustrated by the dashed lines in FIGS. 19 and 22.

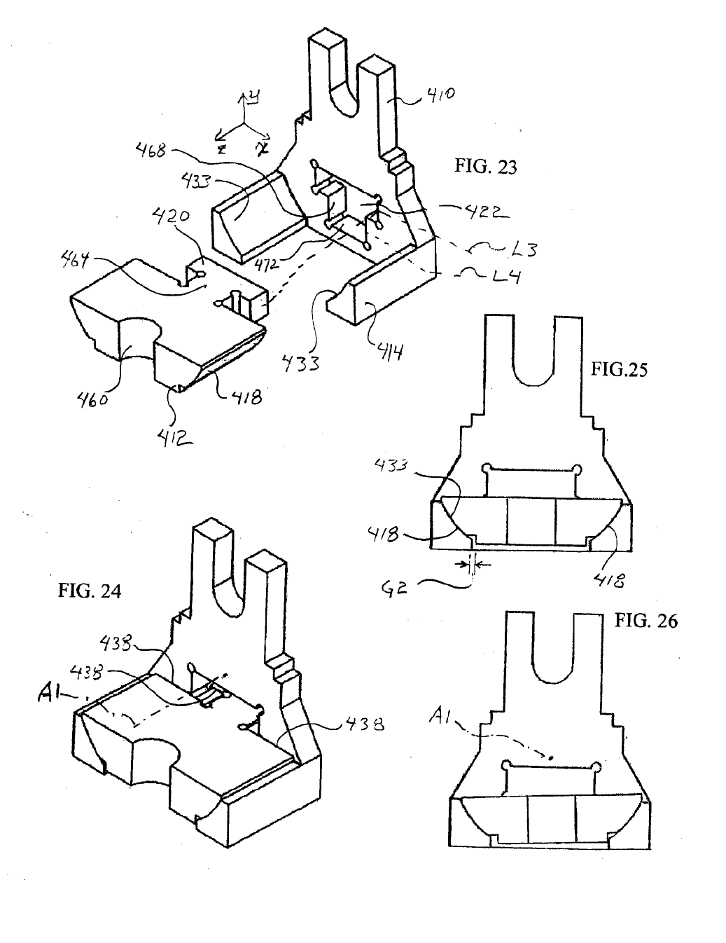

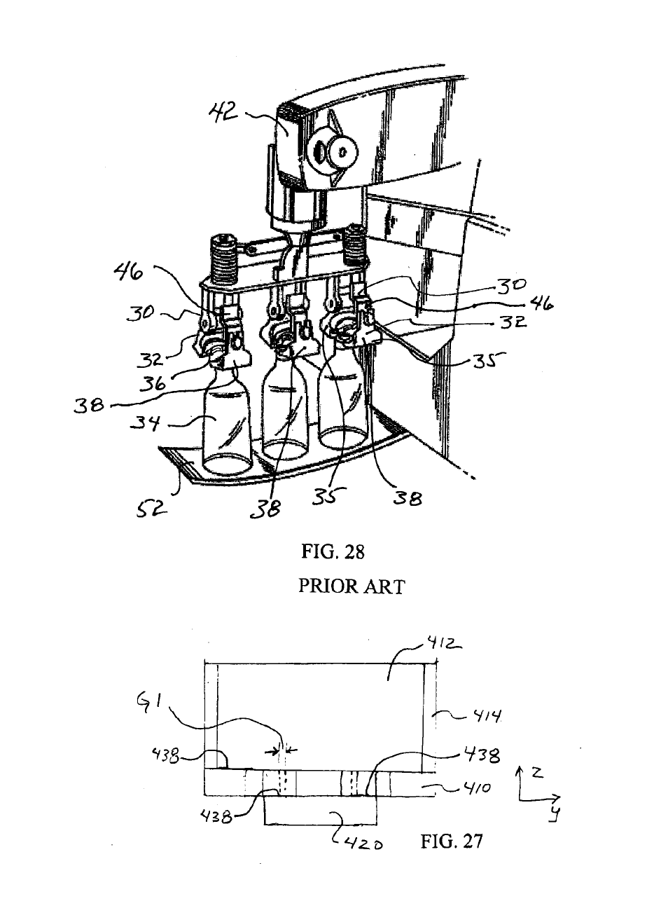

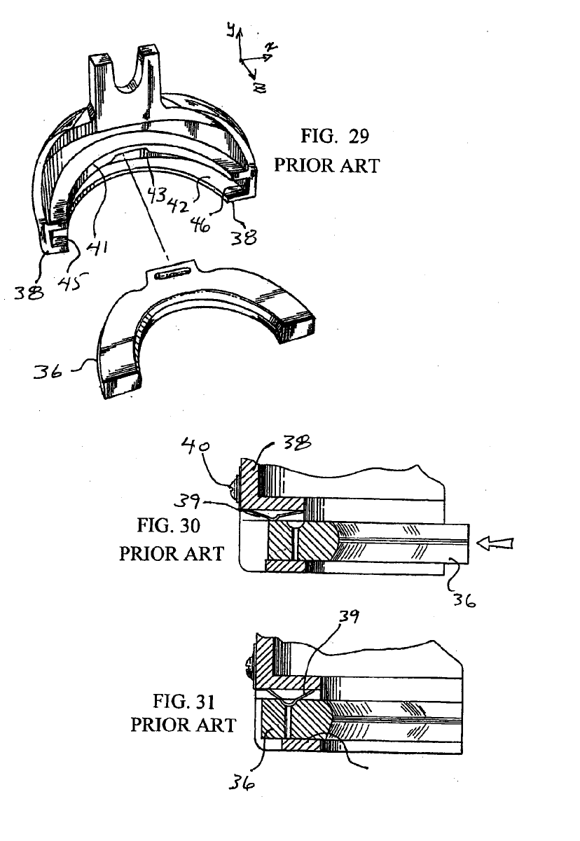

Referring to FIGS. 23-27, an embodiment is illustrated where the insert holder 410 has forwardly extending arms 414 and the insert 412 has a single rearwardly extending projection 420 with a “T” shape. The T-shaped portion 420 is insertable into the insert holder 410 at the T-shaped aperture 422 at a level L3 to be lowered to a level L4 whereby the insert may seat on surface 424 at the bottom of the aperture 422, and whereby surfaces 418 on insert 412 may seat on cooperating curved surfaces 433 on arms 414. Once seated, constraint in the z direction is provided by engagement surfaces 438 of insert 412 that abut front surface 440 of insert holder 410. The interface between curved surfaces 433 on insert holder arms 414 and cooperating insert surfaces 433 allows partial rotation of insert 412 about axis A1 when a moment is applied to the insert. Such moment may occur when the insert holders 410 and inserts 412 are grasping a glass article with a center of gravity below the article grasping cutouts 460, and motion is initiated in the x direction. The amount of rotation may be controlled by the gap G1 between the neck 464 of the T-shaped projection of the insert 412 and the vertical surfaces 468 of the slot 472 within which the neck 464 seats (FIG. 27). Such rotation can further or alternatively be controlled by gap G2 defined by the vertical surface 482 of the insert 412 and a cooperating confronting vertical surface 486 of the insert holder arm 414 (FIGS. 25, 26).

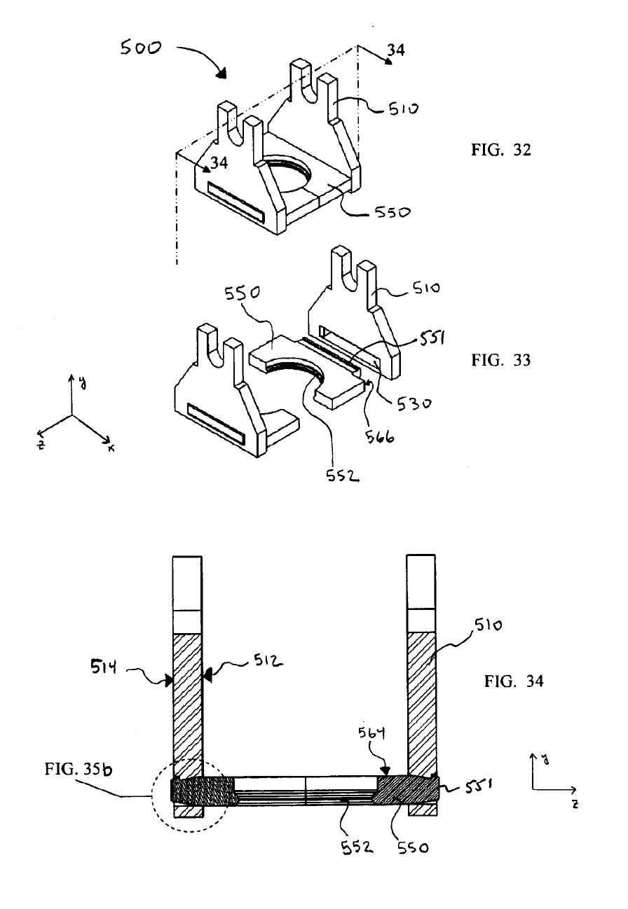

Referring to FIGS. 32-35, a further embodiment is illustrated that utilizes a novel tooth and notch system to retain insert 550, as opposed to a T-shaped insert feature. Similar to previous embodiments, takeout jaw 510 includes inner surface 512, outer surface 514, and insert receiving slot 530. Receiving slot 530 includes a bottom portion 532, which may be substantially planar. The top portion of slot 530, however, includes a notch, which is defined by horizontal notch portion 534 that extends inward from outer takeout jaw surface 514 and vertical notch portion 536 that extends downward therefrom. Top inclined portion 536 extends from the bottom-most portion of vertical notch portion 536 to inner takeout jaw surface 512 at a slightly upward angle.

Insert 550 is similar to previously described inserts in that it includes substantially horizontal top surface 564 and may include molded glass interface portion 552 which may be altered to accommodate various molded glass designs. Again, insert 550 may be formed of a non-conductive, yet strong, insulating material such as graphite. In this particular embodiment, insert 550 includes tooth 558 which is shaped so as to engage with notch 535 of takeout jaw 510, and includes top inclined portion 560 which is shaped so as to engage with top inclined portion 538 of takeout jaw 510. Insert 550 further includes bottom inclined portion 562 which effectively narrows insert 550 near outer face 554 of insert 550 to facilitate the placement of insert 550 into slot 530 of takeout jaw 510.

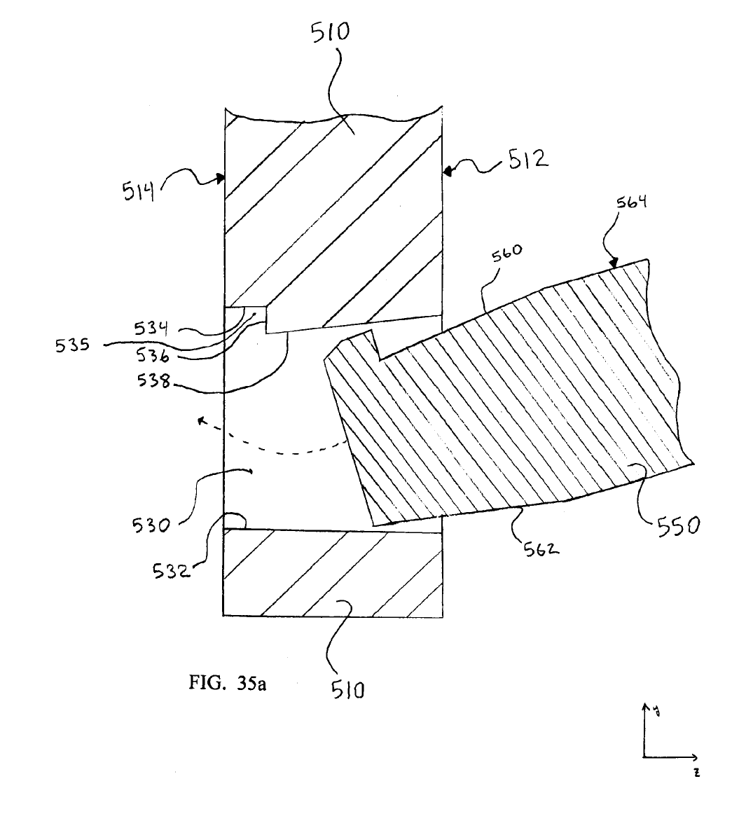

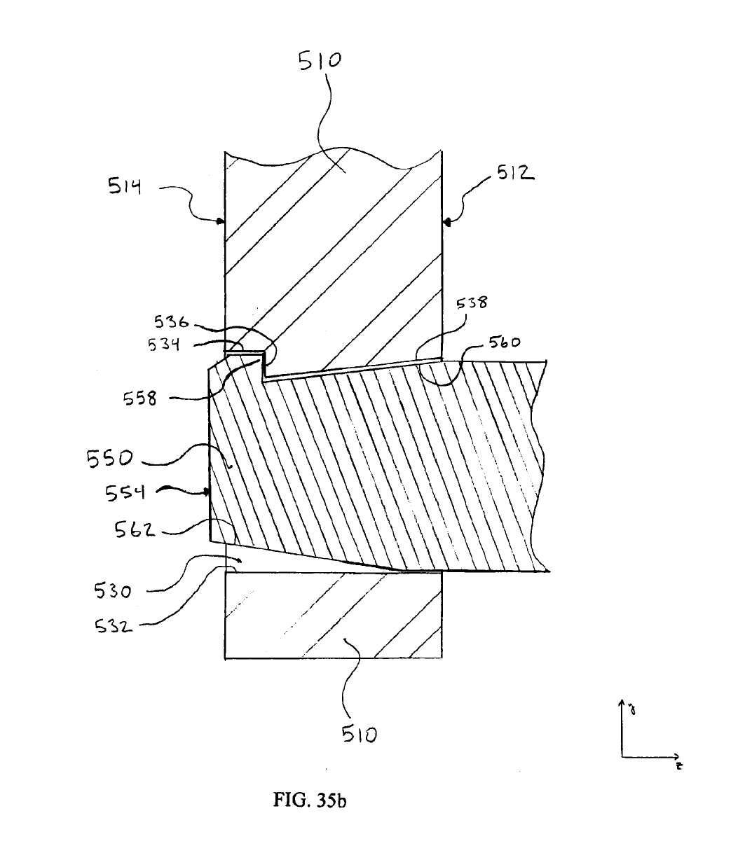

FIGS. 35a and 35b illustrate the installation of insert 550 within slot 530 of takeout jaw 510. As depicted in FIG. 35a, insert 550 must be rotated about the x-axis so that tooth 558 of insert 550 is rotated downward to facilitate installation. Insert 550, specifically the tongue 551, is then pushed into slot 530 in the direction of the dashed arrow shown in FIG. 35a until shoulder 566 contacts inner takeout jaw surface 512, at which time catch or tooth 558 will extend slightly beyond vertical notch member 536. Insert 550 is then rotated back to its original position so that top surface 564 is substantially horizontal. FIG. 35b depicts insert 550 in its final installation position within slot 530 of takeout jaw 510.

The present embodiment provides significant benefits in terms of material usage, ease of assembly, and insert retaining strength. The tooth and notch design foregoes the need for a “T” member, thereby decreasing insert 550 size and providing cost savings due to less material used. Insertion and removal is also easy; one need only rotate an insert 550 and pull it out of or push it into takeout jaws 510. Notably, insert 550 is effectively cantilevered from takeout jaw 510, so that the weight of the insert and the weight of a glass object held by the insert, if present, applies a moment on insert 550, thereby pressing insert tooth portion 558 into notch 535, securing insert 550 to takeout jaw 510. Z-direction movement is also constrained; vertical notch member 536 abuts insert hook portion 558 which prevents inward z-direction movement, and shoulder 566 abuts takeout jaw inner surface 512 which prevents outward z-direction movement.

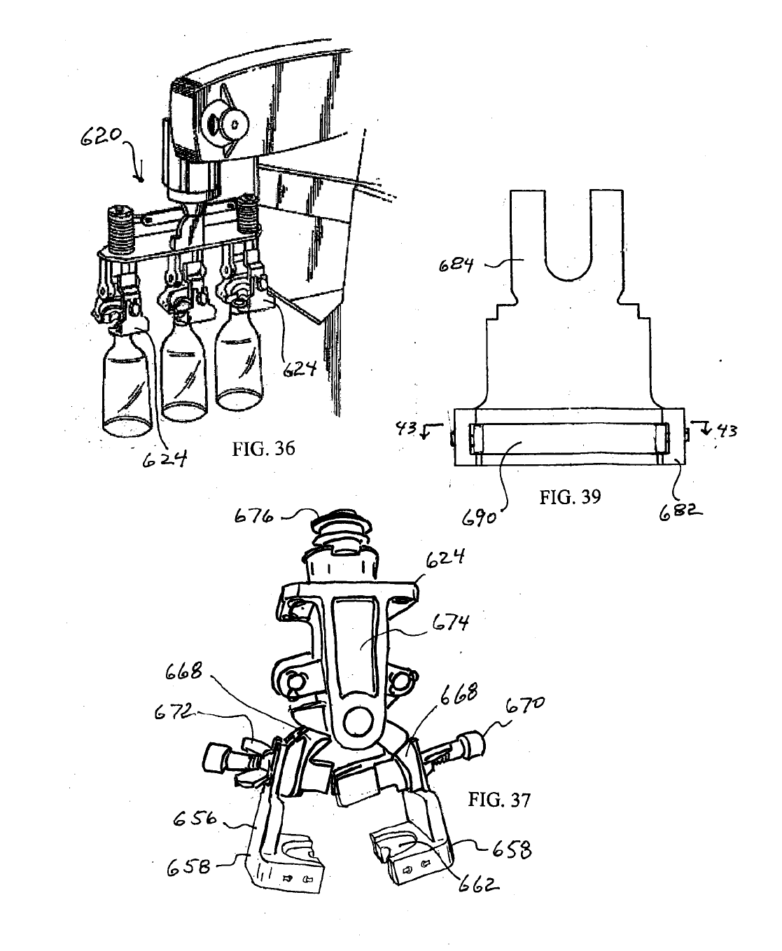

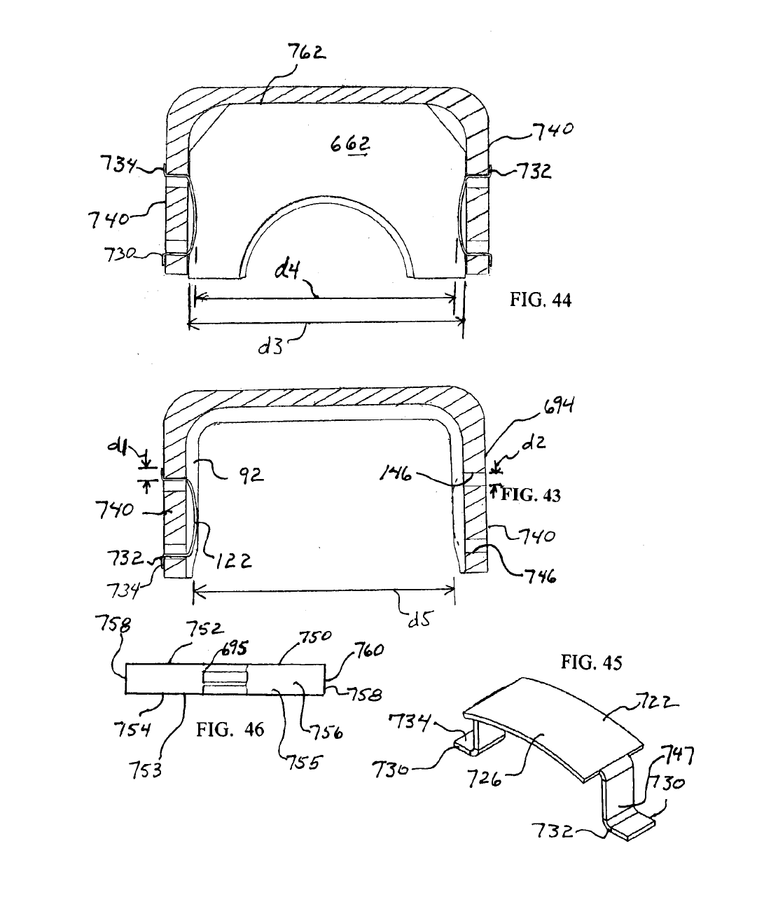

Referring to FIGS. 36-49 an embodiment utilizing insert springs for securing the inserts are illustrated. Referring specifically to FIG. 36, a robotic bottle handling arm 620 is illustrated as part of a takeout area of a glass article manufacturing facility. The arm supports three tong assemblies 624, with an exemplary single tong assembly illustrated in FIG. 37. Each tong assembly 624 has a pair of takeout jaw assemblies 656 comprising a take out jaw or insert holder 658 and inserts 662. The jaw assemblies are secured to tong brackets 668 by way of machine screws 670 and wing nuts 672. The tong assembly has a body portion 674 and actuator 676 for operating the clamping action of the jaws 658. The takeout jaws interface with just molded hot glass bottles or other glass articles, grasping and conveying the bottles or other articles to a suitable conveyor or other location as part of the manufacturing process.

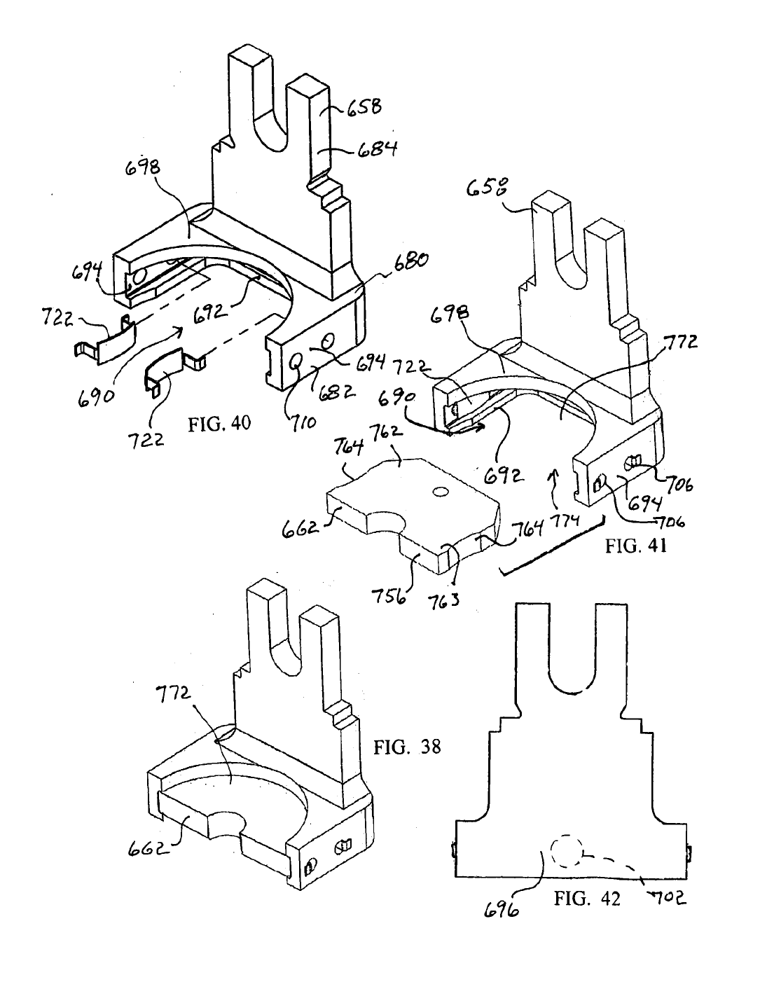

Now referring to FIGS. 38-44, details of the insert holder and insert according to an embodiment of the invention are illustrated. The insert holder 658 may be milled, stamped, cast or otherwise formed out of a metal or metal alloy such as steel, iron, aluminum, bronze and the like. The insert holder has a body portion 680, configured as a takeout jaw insert interface portion 682, and a tong assembly interface portion 684 configured as attachment forks for attachment to the bracket of the tong assembly. The takeout jaw insert interface portion has an insert receiving slot or pocket 690. The slot is defined by a lower shelf 692, side walls 694, back wall 696, and upper shelf 698.

The insert slot 690 is open at the front and substantially closed at the rear, except for an optional takeout jaw access port 702 which may be located on the back wall 696 of the insert interface portion 682. The side walls 694 at the insert interface portion have a plurality of spring clip interface portions 706 configured as through holes 710. A pair of arcuate springs 722, configured as spring clips, are attachable to the holes. Each spring clip 722 has a midportion 726 that provides the arcuate shape and end portions 730 configured as tabs with corner portions 732 and end tab portion 734 for securement to the sidewalls of the insert holder at the holes therein. The spring resiliency provides for the entrapment of the spring clip to the insert holder as well as providing resiliency for retention of the insert in the insert holder.

Continuing to refer to FIGS. 38-44, depict a configuration of the spring clip connection portions 636 according to an embodiment of the invention. The spring clip connection portions 706 may be oriented towards the front of and vertically centered in the insert interface slot 690. In this configuration, the majority of the insert would be oriented behind the center of the spring clips 722. This will facilitate the retention of the insert within the pocket during the potential thousands of cycles of the jaws opening and closing and the inserts clamping on bottles or other glass articles.

Referring in particular to FIGS. 43-45, the arcuate springs 722 may be positioned on each side 740 of the insert holders utilizing the pairs of holes 710 on said sides of the insert holders. The holes are suitably spaced and the spring configured to require the respective spring to be flexed, such as having the end portions compressed inwardly to allow the tabs to be inserted in the holes. The lengthwise dimension d1 of the end tab portion is sized to be less than the diameter d2 of the through holes 710 allowing the insertion of the end portions through the holes, see in particular FIG. 43. The tension in the respective spring is released after the tabs are extending through the holes, whereby the end tab portions 734 confront the outside surface 740 of the side walls 694 thereby securing the spring in place. The holes have a spring engagement surface 746 which engage or confront the spring clips when the spring clip is released. The engagement surface may also engage the spring clip, at an insert holder engagement surface 747, when the spring is flexed during insertion of an insert and when the insert is fully seated. The arcuate shape of the spring at the midportion of the spring extends into the insert slot providing an interference fit with inserts that are received by the slot. The inserts 662 each have a flat and parallel top side 750 with a top surface 752, a lower side 753 with a lower surface 754, a front side 755 with a front surface 756, and a pair of sides 758 with side surfaces 760. A cutaway or arcuate recess 764 positioned on each of the sides of the inserts cooperates with the arcuate spring when the insert is fully received in the insert holder such that the insert is secured in place. The recess may conform to the shape of the mid portion of the spring clip.

The opposing spring clips on opposite sides of the insert holder slot cooperate to enhance the retention of the insert within the slot. That is removal of the insert from the slot configured as illustrated, will require deflection of the arcuate midportion of both of the spring clips. This occurs when the rear corner portions 762 are pulled toward the spring clips and out the front of the slot. The corner portions have a greater cross width dimension d3 than the cross width dimension d4 of the narrow portion of the insert at the deepest portion of the pair of side recesses 764. Moreover, the shape of the spring clip may ideally be configured to conform to the shape of the recesses in the inserts.

In an embodiment, the arcuate springs have tabs arranged to extend outwardly, when said springs are seated in the insert holder, and when an insert is being inserted therein, the arcuate spring extends, that is, the arcuate shape flattens, whereby the tabs are urged outwardly, in the direction opposite to the direction needed to release the spring from the insert holder. This effectively locks the springs in place when they are being utilized for retention of the inserts.

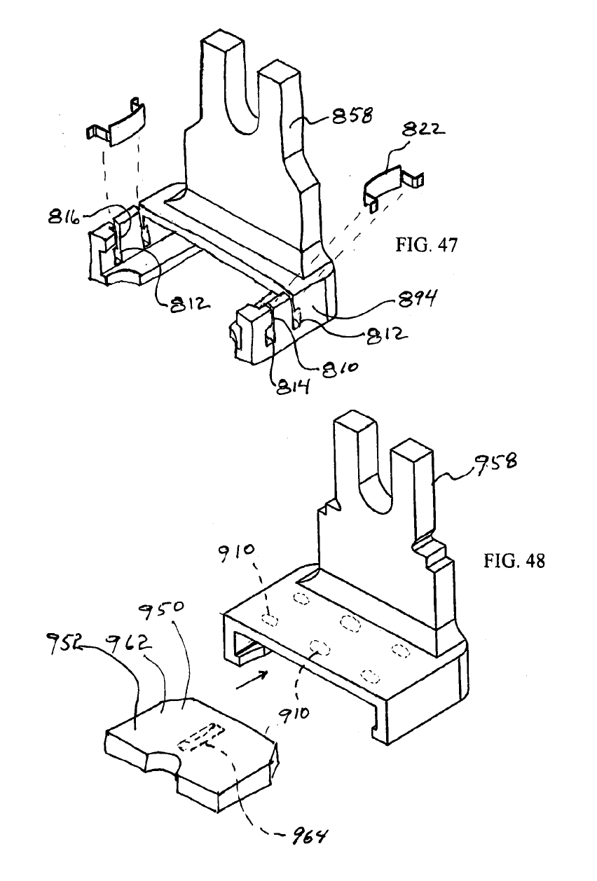

Referring to FIG. 47, in this takeout jaw 858, the spring clips 822 may engage the insert holder by way the spring clip interface portion 810 configured as a pair of slots 812 extending downwardly from the top side of the insert holder, for example, downwardly from the upper side at the side walls 894. A pair of slots can be provided for which the spring clip needs to be flexed, for example compressed, in order for the spring clip to fit therein. When in place the force providing the flexing is released and the spring clip is captured in the takeout jaw. In this embodiment the spring clip engagement portion has a seating portion 814 and a placement slot 816.

Referring to FIG. 48, another embodiment is illustrated in which the dashed lines indicate possible locations for the spring clip interface portions 910 of the insert holder 958 and an insert 962 is illustrated with a recess 964 positioned on the top side 950 at the top surface 952. The spring clips are typically arranged to have their lengthwise dimension be parallel to the direction of insertion of the inserts.

The takeout jaw access slot 690 as depicted in the figures is utilized to allow for the efficient replacement and maintenance of the inserts. In some embodiments, for example the embodiment of FIG. 41, the support personnel could utilize the open areas 772, 774 on the insert holder to quickly remove the insert 662 from the insert interface pocket 690 simply by manually grasping the insert and pulling the insert out. Additionally or alternatively, the support personnel may utilize a small takeout jaw insert push tool or a screwdriver or other tool capable of passing through the takeout jaw access port 702 on the back of the insert holder. In this way the support personnel may be able to replace an insert 662 quickly and efficiently, thus reducing assembly line downtime.

The takeout jaw insert 662 may be formed of a very low conductive, yet strong, insulating material such as graphite. Graphite is a rigid insulator and enables the molded glass to cool slowly, as the graphite does not transmit heat away from the molded glass as readily due to its chemical structure. Further, graphite is strong enough to resist cracking after repeated use and repeated contact with molded glass. Finally graphite is readily formed and lightweight, thus reducing lead time in creation and cost of replacement parts. Various grades of graphite are commercially available. One particularly desirable material is a fine particle, high strength, isotropic graphite available from PCO Graphite, Inc. which is sold as GLASSMATE® graphite contact material which is available in various grades.

The takeout jaw insert 662 may have glass contact edges 695. The glass contact edges 695 may be semi-circular. Further, the molded glass contact edges 695 may be threaded contact edges, or may be ridged contact edges as depicted in FIG. 46. In various embodiments the molded glass contact edge 695 profile design may be altered in order to accommodate various different molded glass designs. In this way, the takeout jaw insert 662 may be utilized in a variety of assembly lines that form a variety of glass types. Further, variations in the glass contact edges 694 allow for varying amounts of play and float that are required on various production lines.

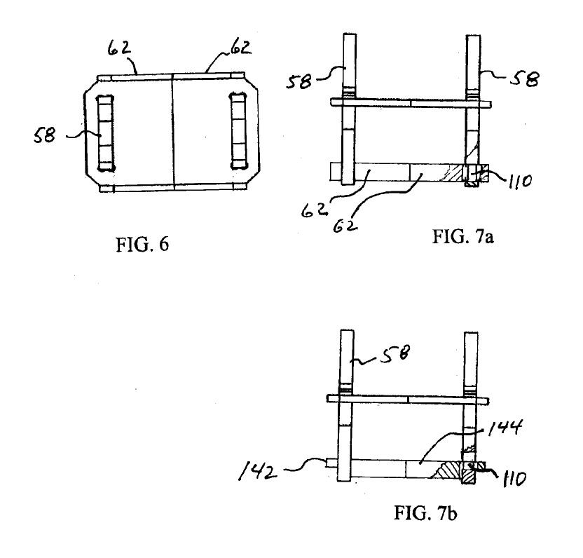

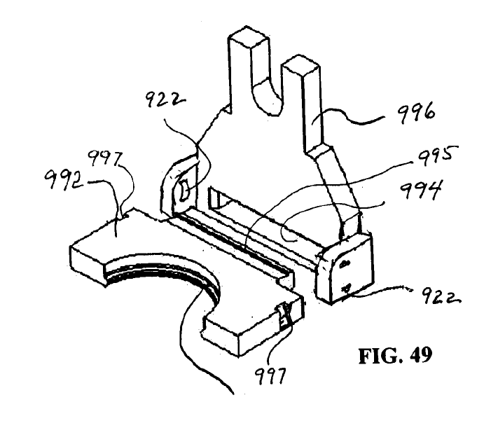

Referring to FIG. 49, another embodiment is illustrated in the spring clip interface is used in conjunction with the gravity seated aspects. Insert 992 seats in the insert holder 996 with the tongue 995 being inserted into the slot 994 as discussed above in the text associated with FIGS. 32-35b. When the insert is rotated downward to seat, further retention is provided by the springs 922 engaged in notches 997. The spring may be retained as discussed above in association with FIGS. 36-48 or in certain embodiments may be as disclosed in U.S. Pat. No. 4,995,896, incorporated herein by reference. Also, the configurations of the other inserts such as in FIGS. 2-26, may be used in conjunction with the springs as disclosed herein.

The embodiments above are intended to be illustrative and not limiting. Additional embodiments are within the claims. In addition, although aspects of the present invention have been described with reference to particular embodiments, those skilled in the art will recognize that changes can be made in form and detail without departing from the spirit and scope of the invention, as defined by the claims.

Persons of ordinary skill in the relevant arts will recognize that the invention may comprise fewer features than illustrated in any individual embodiment described above. The embodiments described herein are not meant to be an exhaustive presentation of the ways in which the various features of the invention may be combined. Accordingly, the embodiments are not mutually exclusive combinations of features; rather, the invention may comprise a combination of different individual features selected from different individual embodiments, as understood by persons of ordinary skill in the art.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims for the present invention, it is expressly intended that the provisions of Section 212, sixth paragraph of 35 U.S.C. are not to be invoked unless the specific terms “means for” or “step for” are recited in a claim.

1. A takeout jaw assembly comprising:
a takeout jaw comprising a tong assembly interface portion; and
a takeout jaw insert interface portion wherein the tong assembly interface portion and takeout jaw insert interface portion are formed from a single piece of material;
a non-metallic takeout jaw insert comprising a body having front and rear edges; and a molded glass article interface portion formed at the front edge of the body by cut-outs and a takeout jaw interface portion formed at the rear edge of the body by cut-outs wherein the takeout jaw interface portion is in mating relation to the takeout jaw insert interface portion to retain the takeout jaw insert in operational contact with the takeout jaw insert interface portion without separate retention components.

2. The takeout jaw assembly of claim 1 wherein the takeout jaw insert is interlockingly retained in place with respect to the takeout jaw by gravity.

3. The takeout jaw assembly of claim 2 wherein the takeout jaw interface portion and the insert interface portion are configured such that the insert needs to be vertically raised and moved horizontally to separate the insert from the takeout jaw.

4. The takeout jaw assembly of claim 1 wherein the takeout jaw insert body is generally rectangular, having a substantially planar upper surface, a substantially planar bottom surface substantially parallel with the upper surface, a front side and a rear side, the front side having a front surface having a concave surface defining a glass contacting edge, the glass contacting edge being precision mateable with a glass article, a rear side having a takeout jaw interface portion, the takeout jaw interface portion having a pair of C-shaped cut-outs when viewed from above in the body for engagement of a takeout jaw insert interface.

5. The takeout jaw insert of claim 4 wherein the glass contacting edge further comprises helical reliefs for contacting threaded bottles.

6. A takeout jaw assembly comprising:
a takeout jaw comprising a tong assembly interface portion at an upper end and a takeout jaw insert interface portion at a lower end;
a non-metallic takeout jaw insert comprising a body having front and rear edges, a molded glass article interface portion formed at the front edge of the body, and a takeout jaw interface portion formed at the rear edge of the body;
wherein one of the jaw insert interface portion and the takeout jaw interface portion having a vertically extending slot having an upward entry region and the other of the jaw insert interface portion and the takeout jaw interface portion having an engagement portion configured to be downwardly inserted into said vertically extending slot to be captured therein.

7. A takeout jaw assembly comprising a takeout jaw and an insert that seats thereon, the takeout jaw having a front side, a rear side, a forwardly oriented vertical surface that engages a rearwardly oriented surface of the insert, the takeout jaw having a rearwardly facing surface that cooperate with a forward facing surface of the insert thereby securing the insert with regard to a forward rearward direction, the takeout jaw having a pair of inwardly and upwardly oriented curved surfaces that engage a cooperating pair of downwardly and outwardly oriented surfaces of the insert.

8. The takeout jaw assembly of claim 1 wherein the takeout jaw insert further comprises a T-shaped projection for engaging the takeout jaw.

9. The takeout jaw assembly of claim 8 wherein insert holder further comprises a T-shaped aperture for receiving the T-shaped projection.

10. The takeout jaw assembly of claim 7 wherein the engagement of the pair of inwardly and upwardly oriented curved surfaces with the cooperating pair of downwardly and outwardly oriented surfaces of the insert is a sliding engagement whereby the insert may partially rotate about an axis extending forwardly and rearwardly.

11. The takeout jaw assembly of claim 1 wherein the takeout jaw interface portion has a C-shaped portion that extends partially around the takeout jaw insert thereby capturing the insert therein.

12. A takeout jaw assembly comprising:
a takeout jaw comprising a tong assembly interface portion including a retention notch;
a takeout jaw insert interface portion wherein the tong assembly interface portion and takeout jaw insert interface portion are formed from a single piece of material;
a non-metallic takeout jaw insert comprising a body having front and rear edges, and a molded glass article interface portion formed at the front edge of the body by cut-outs and a takeout jaw interface portion formed at the rear edge of the body including a tooth portion, wherein the takeout jaw interface portion including retention notch is in mating relation to the takeout jaw insert interface portion including tooth to retain the takeout jaw insert in operational contact with the takeout jaw insert interface portion without separate retention components.

13. The takeout jaw assembly of claim 12 wherein the takeout jaw insert is interlockingly retained in place with respect to the takeout jaw by gravity.

14. The takeout jaw assembly of claim 13 wherein the takeout jaw interface portion and the insert interface portion are configured such that the insert needs to be rotated and moved horizontally to separate the insert from the takeout jaw.

15. (canceled)

16. The takeout jaw assembly of claim 1 wherein the insert has and upwardly extending catch that requires the insert to be inserted into the insert holder at an angle from horizontal and that then when the insert is rotated downward to horizontal, the catch engages with the insert holder to retain the insert in place.

17. A method of replacing inserts in a tong assembly for grasping and conveying bottles or jars, the method comprising the steps of:
lifting the existing inserts upwardly from their seats on the respective takeout jaws, thereby unseating the existing inserts and removing said existing inserts from the takeout jaw; and
lowering new inserts onto the seats of the respective inserts, relying exclusively upon gravity to retain the inserts on their seats.

18. The method of claim 15, further comprising the step of engaging interlocking portions of the new inserts with interlocking portions of the respective takeout jaws as the new inserts are lowered onto the seats of the respective inserts.

19. The method of claim 15 wherein the existing inserts are captured when they are seated on the respective takeout jaws, the method further comprising the step of releasing the insert from the respective capture as the inserts are lifted.

20. A method of securing a matched pair of inwardly extending horizontal confronting components to pair of takeout jaws of a tong assembly for glass article manufacturing without utilizing mechanical fasteners for retention of the components, the tongs openable and closable for grasping the top portion of a glass article, the method comprising the steps of:
providing a pair of cooperating matched horizontally extending pieces with each piece having a front confronting edge and a takeout jaw interface portion, the takeout jaw interface portion having takeout jaw interlocking portions;
placing each of the takeout jaw engagement portions directly over a cooperating interlocking portions of the respective takeout jaws in engaging alignment; and
vertically lowering the matched pair of horizontally confronting components to seat on the takeout jaws such that each of the pieces seats on a horizontal surface of the takeout jaw, and the interlocking portions of the horizontally confronting components are respectively interlocked with the respective interlocking portions of the takeout jaws whereby the horizontally extending pieces are downwardly constrained, laterally constrained, rotationally restrained, but not upwardly restrained, whereby no fasteners are utilized to secure the pieces to the respective takeout jaws and the pieces remain seated by gravitational force such that each of the matched pair has the confronting edge extending inwardly toward the other of the matched pair.

21-30. (canceled)

31. A method of providing float to a takeout jaw assembly, the takeout jaw assembly comprising a takeout jaw and an insert adapted to engage therewith, the method comprising:
utilizing curved upwardly and inwardly oriented curved surfaces on the takeout jaw that slidingly interface with curved downwardly and outwardly oriented surfaces on the insert.

32-39. (canceled)

40. The takeout jaw assembly of claim 7 wherein the takeout jaw insert further comprises a T-shaped projection for engaging the takeout jaw.

41. The takeout jaw assembly of claim 40 wherein insert holder further comprises a T-shaped aperture for receiving the T-shaped projection.

42. The takeout jaw assembly of claim 1 wherein the takeout jaw interface portion of the takeout jaw insert has a C-shaped portion that extends partially around the takeout jaw thereby capturing the takeout jaw therein.

43. The takeout jaw assembly of claim 7 wherein the insert has and upwardly extending catch that requires the insert to be inserted into the insert holder at an angle from horizontal and that then when the insert is rotated downward to horizontal, the catch engages with the insert holder to retain the insert in place.
